(19) United States
(12) Patent Application Publication
(10) Pub. No.: US 2015/0116195 A1
(43) Pub. Date: Apr. 30, 2015

(54) LIQUID CRYSTAL DISPLAY DEVICE, ELECTRONIC DEVICE INCLUDING THE SAME, AND METHOD FOR DRIVING LIQUID CRYSTAL DISPLAY DEVICE

(71) Applicant: Sharp Kabushiki Kaisha, Osaka-shi, Osaka (JP)

(72) Inventor: Shinsuke Yokonuma, Osaka-shi (JP)

(21) Appl. No.: 14/402,894

(22) PCT Filed: Apr. 26, 2013
(86) PCT No.: PCT/JP2013/062350

§ 371 Date: Nov. 21, 2014

(30) Foreign Application Priority Data
Jun. 18, 2012 (JP) 2012-136977

(51) Int. Cl. G09G 3/36; G09G 3/34

(52) U.S. Cl. CPC G09G 3/3611; G09G 3/3406; G09G 2310/08; G09G 2320/0247; G09G 2320/064; G09G 2330/02; G09G 2340/0435; G09G 2360/144
USPC 345/102

(57) ABSTRACT

There is provided a liquid crystal display device capable of suppressing deterioration in display quality depending on an ambient illuminance at low cost. A mobile device includes a liquid crystal display device, an optical sensor, and an MPU. The optical sensor acquires an ambient illuminance IL, and the MPU supplies a command CM based on the relevant ambient illuminance IL to the liquid crystal display device. A resistor inside the liquid crystal device selects a drive frequency DF in accordance with the ambient illuminance IL, based on the command CM received through an input signal control circuit. A TG respectively supplies a source control signal SCT and a gate control signal GCT to a source driver and a gate driver, based on the drive frequency DF selected by the resistor.

### TECHNICAL FIELD

The present invention relates to a liquid crystal display device, and particularly to a liquid crystal display device that performs low-frequency refresh drive, an electronic device including the same, and a method for driving the liquid crystal display device.

### BACKGROUND ART

Conventionally, reduction in power consumption has been demanded in a display device such as a liquid crystal display device and the like. Consequently, in recent years, development of a liquid crystal display device employing a drive method has been promoted, in which after a refresh period when gate lines of the liquid crystal display device are scanned to refresh a screen (also referred to as a scanning period, a charging period, or a writing period or the like), a pause period when all the gate lines are put into a non-scanning state to pause the refresh (also referred to as a non-refresh period) is provided. In the pause period, for example, a gate driver and/or a source driver can be inhibited from being supplied with signals for control or the like. Since this enables operations of the gate driver and/or the source driver to be paused, power consumption can be reduced. In this manner, the drive in which the pause period is provided after the refresh period is referred to as “low-frequency refresh drive”. This low-frequency refresh drive is also referred to as “pause drive” or “intermittent drive” or the like.

In an active matrix-type liquid crystal panel, TFTs (Thin Film Transistors) are generally used as switching elements. When light (e.g., outside light or the like) enters a channel layer of each of the TFTs, an internal photoelectric effect occurs. This internal photoelectric effect excites conduction electrons to increase conductivity, and thus, a leak current caused in an off state of the TFT (hereinafter, referred to as “at off time”) is increased. This makes a reduction amount of electric charge to be held at the off time large, thereby making fluctuation of a liquid crystal application voltage to be held large. Accordingly, a transmittance largely changes, and flicker is visually recognized. This flicker causes deterioration in display quality. Moreover, since a magnitude of the leak current differs depending on an illumination of the outside light (hereinafter, referred to as an “ambient illuminance”), change of the transmittance at the off time also differs depending on the ambient illuminance. That is, an extent of the deterioration in display quality depends on the ambient illuminance. Furthermore, in the low-frequency refresh drive, a period when the liquid crystal application voltage is held is longer than that in drive in which the pause period is not provided after the refresh period, that is, drive in which the refresh period continuously appears (hereinafter, referred to as “ordinary drive”, and thus, the deterioration in display quality depending on the ambient illuminance notably appears.

In connection with the invention of the present application, in Japanese Patent Application Laid-Open No. 2011-170342, there is described a liquid crystal display device in which an optical sensor is provided in the vicinity of an end portion of a liquid crystal panel, and pixels for monitoring to enhance photodetection sensitivity are formed in the liquid crystal panel. The optical sensor is, more specifically, provided between the liquid crystal panel and a casing, and at a position where outside light does not directly enter. The pixels for monitoring are formed outside a display area of the liquid crystal panel, and at a position opposed to the optical sensor. In a back surface of the liquid crystal panel, a backlight that performs luminance control in accordance with the ambient illuminance is provided. As the switching elements inside the liquid crystal panel, TFTs each having a relatively small leak current are used. In the liquid crystal panel, a still picture is displayed by supplying a potential to the pixels for monitoring and pixels formed inside the display area (hereinafter, referred to as “ordinary pixels”). Mainly, light passing through a liquid crystal layer of the pixels for monitoring is detected by the optical sensor, and at a time point when a change rate of the illuminance of the relevant light reaches a default value or more, a potential is resupplied to the pixels for monitoring and the pixels formed inside the display area (the refresh is performed). This allows the refresh to be performed at intervals in accordance with the ambient illuminance. This can suppress the deterioration in display quality depending on the ambient illuminance.

### PRIOR ART DOCUMENT

### Patent Document

[Patent Document 1] Japanese Patent Application Laid-Open No. 2011-170342

### SUMMARY OF THE INVENTION

### Problems to be Solved by the Invention

In the liquid crystal display device described in Japanese Patent Application Laid-Open No. 2011-170342, as described above, in addition to the ordinary pixels, the pixels for monitoring need to be formed inside the liquid crystal panel. This makes it necessary to configure a dedicated circuit inside the liquid crystal panel, thereby increasing costs.

Therefore, an object of the present invention is to provide a liquid crystal display device capable of suppressing deterioration in display quality depending on an ambient illuminance at low cost, an electronic device including the same, and a method for driving the liquid crystal display device.

### Means for Solving the Problems

According to a first aspect of the present invention, there is provided a liquid crystal display device including: a liquid crystal panel including a plurality of scanning lines, a plurality of data lines, and a plurality of pixel formation portions provided corresponding to the plurality of scanning lines and the plurality of data lines; and a display control unit that controls drive of the plurality of scanning lines and the plurality of data lines, wherein each of the pixel formation portions includes a thin film transistor having a gate terminal connected to the corresponding scanning line, and a pixel electrode connected to the corresponding data line through the thin film transistor, and the display control unit includes: an input unit that receives an input signal for control based on an ambient illuminance from outside; and a drive frequency control unit that sets a drive frequency determined by a ratio between a refresh period and a pause period to a value in accordance with the ambient illuminance, based on the input signal for control, when the plurality of scanning lines and the plurality of data lines are to be driven so that the refresh period and the pause period alternately appear, the refresh period being for refreshing a screen of the liquid crystal panel, and the pause period being for pausing the refresh of the screen, the pause period being equal to or longer than the refresh period.

According to a second aspect of the present invention, in the first aspect of the present invention, the drive frequency control unit includes: a storage unit that prestores a plurality of types of drive frequencies, and selects the drive frequency in accordance with the ambient illuminance from the plurality of types of drive frequencies, based on the input signal for control; and a drive control unit that controls drive timing of the plurality of scanning lines and the plurality of data lines, based on the drive frequency selected by the storage unit, when the plurality of scanning lines and the plurality of data lines are to be driven so that the refresh period and the pause period alternately appear.

According to a third aspect of the present invention, in the second aspect of the present invention, the liquid crystal display device further includes a light source unit that radiates light to the liquid crystal panel and a light source control unit that controls the light source unit.

According to a fourth aspect of the present invention, in the third aspect of the present invention, the light source control unit controls a luminance of light to be radiated from the light source unit, based on a lighting control signal subjected to pulse width modulation.

According to a fifth aspect of the present invention, in the fourth aspect of the present invention, the light source control unit makes the luminance of the light to be radiated from the light source unit higher as a duty ratio of the lighting control signal is higher.

According to a sixth aspect of the present invention, in the fifth aspect of the present invention, the display control unit further includes a lighting control signal generating unit that generates the lighting control signal, and the lighting control signal generating unit determines the duty ratio of the lighting control signal, based on the drive frequency.

According to a seventh aspect of the present invention, in the sixth aspect of the present invention, the drive control unit controls the duty ratio of the lighting control signal to be determined by the lighting control signal generating unit.

According to an eighth aspect of the present invention, in the fifth aspect of the present invention, the drive control unit generates the lighting control signal having the duty ratio based on the drive frequency.

According to a ninth aspect of the present invention, in the first aspect of the present invention, the drive frequency control unit sets the drive frequency to a predetermined value, when the plurality of scanning lines and the plurality of data lines are to be driven so that the refresh period continuously appears.

According to a tenth aspect of the present invention, in the first aspect of the present invention, a channel layer of the thin film transistor is formed of an oxide semiconductor.

According to an eleventh aspect of the present invention, in the fifth aspect of the present invention, the light source control unit receives the lighting control signal having the duty ratio based on the ambient illuminance from outside the liquid crystal display device.

According to a twelfth aspect of the present invention, there is provided an electronic device liquid crystal display device including: the liquid crystal display device according to any one of the first to tenth aspect of the present invention; an ambient illuminance acquiring unit that acquires the ambient illuminance; and an information processing unit that supplies to the input unit an input signal for control based on the ambient illuminance acquired by the ambient illuminance acquiring unit.

According to a thirteenth aspect of the present invention, there is provided an electronic device including: the liquid crystal display device according to the eleventh aspect of the present invention; an ambient illuminance acquiring unit that acquires the ambient illuminance; and an information processing unit that supplies to the input unit an input signal for control based on the ambient illuminance acquired by the ambient illuminance acquiring unit, and supplies to the light source control unit a lighting control signal having a duty ratio based on the relevant ambient illuminance.

According to a fourteenth aspect of the present invention, there is provided a method for driving a liquid crystal display device which includes a liquid crystal panel and a display control unit, the liquid crystal panel including a plurality of scanning lines, a plurality of data lines, and a plurality of pixel formation portions provided corresponding to the plurality of scanning lines and the plurality of data lines, each of the pixel formation portions including a thin film transistor having a gate terminal connected to the corresponding scanning line, and a pixel electrode connected to the corresponding data line through the thin film transistor, and the display control unit configured to control drive of the plurality of scanning lines and the plurality of data lines, the method including the steps of: receiving an input signal for control based on an ambient illuminance from outside; and setting a drive frequency determined by a ratio between a refresh period and a pause period to a value in accordance with the ambient illuminance, based on the input signal for control, when the plurality of scanning lines and the plurality of data lines are to be driven so that the refresh period and the pause period alternately appear, the refresh period being for refreshing a screen of the liquid crystal panel, and the pause period being for pausing the refresh of the screen, the pause period being equal to or longer than the refresh period.

### Effects of the Invention

According to the first aspect of the present invention, the drive frequency is determined in accordance with the ambient illuminance at the time of the low-frequency refresh drive. This allows the refresh to be performed at intervals in accordance with the ambient illuminance. Moreover, since the operation in accordance with the ambient illuminance is performed based on the input signal for control supplied from the outside of the liquid crystal display device, a dedicated circuit does not need to be provided inside the liquid crystal panel. Accordingly, the deterioration in display quality depending on the ambient illuminance can be suppressed at low cost.

According to the second aspect of the present invention, the drive frequency in accordance with the ambient illuminance is selected from the plurality of types of drive frequencies prestored in the storage unit, so that the drive based on the relevant drive frequency is performed. This makes it unnecessary to calculate the drive frequency every time the display control unit receives the input signal for control. Since this makes it unnecessary to separately provide a circuit to calculate the drive frequency, or the like, the costs can be further reduced.

According to the third aspect of the present invention, the liquid crystal panel controls a transmittance of the light radiated from the light source unit (hereinafter, referred to as “light from a light source” in description of effects of the invention), so that image display can be performed.

According to the fourth aspect of the present invention, since the luminance of the light from the light source is controlled based on the lighting control signal subjected to the pulse width modulation, the image display based on the appropriate luminance of the light from the light source can be performed.

According to the fifth aspect of the present invention, the luminance of the light from the light source is controlled based on the duty ratio of the lighting control signal, so that a similar effect to that of the fourth aspect of the present invention can be obtained.

According to the sixth aspect of the present invention, the lighting control signal generating unit is provided in the display control unit to generate the lighting control signal having the duty ratio based on the drive frequency in the relevant lighting control signal generating unit, so that the luminance of the light from the light source is changed along with the change of the transmittance when the refresh is performed at the intervals in accordance with the ambient illuminance. This can further suppress the deterioration in display quality.

According to the seventh aspect of the present invention, the drive control unit that controls the drive timing of the plurality of scanning lines and the plurality of data lines controls the duty ratio of the lighting control signal, so that a similar effect to that of the sixth aspect of the present invention can be obtained while the luminance of the light from the light source is more reliably synchronized with the relevant drive timing.

According to the eighth aspect of the present invention, the drive control unit that controls the drive timing of the plurality of scanning lines and the plurality of data lines generates the lighting control signal, so that a similar effect to that of the seventh aspect of the present invention can be obtained.

According to the ninth aspect of the present invention, not only the low-frequency refresh drive but the ordinary drive can be performed.

According to the tenth aspect of the present invention, the thin film transistor whose channel layer is formed of the oxide semiconductor is used as the thin film transistor inside the pixel formation portion. This can sufficiently hold a voltage (a liquid crystal application voltage) written in the pixel formation portion. Accordingly, deterioration in display quality is hardly caused even if a long pause period is provided.

According to the eleventh aspect of the present invention, the lighting control signal having the duty ratio based on the ambient illuminance is received from the outside, so that a similar effect to that of the sixth aspect of the present invention can be obtained.

According to the twelfth aspect of the present invention, in the electronic device, the ambient illuminance is acquired in the ambient illuminance acquiring unit, and the input signal for control based on the ambient illuminance is supplied from the information processing unit to the input unit, so that a similar effect to any of those of the first aspect to the tenth aspect of the present invention can be obtained.

According to the thirteenth aspect of the present invention, in the electronic device, the ambient illuminance is acquired in the ambient illuminance acquiring unit, and the input signal for control based on the ambient illuminance and the lighting control signal having the duty ratio based on the ambient illumination are supplied from the information processing unit to the input unit and the light source control unit, respectively, so that a similar effect to that of the eleventh aspect of the present invention can be obtained.

According to the fourteenth aspect of the present invention, a similar effect to that of the first aspect of the present invention can be obtained in the method for driving the liquid crystal display device.

### BRIEF DESCRIPTION OF THE DRAWINGS

FIG. 1 is a block diagram showing a configuration of a mobile device according to a first embodiment of the present invention.

FIG. 2 is a block diagram for describing a configuration of a display unit in the first embodiment.

FIGS. 3(A) and 3(B) are diagrams schematically showing chronological change of a flicker rate in accordance with an ambient illuminance when refresh is not performed again after refresh. FIG. 3(A) is a diagram schematically showing the chronological change of the flicker rate under outdoor sunlight, and FIG. 3(B) is a diagram schematically showing the chronological change of the flicker rate under indoor fluorescent light.

FIGS. 4(A) and 4(B) are diagrams schematically showing chronological change of the flicker rate in accordance with the ambient illuminance in the first embodiment. FIG. 4(A) is a diagram schematically showing the chronological change of the flicker rate under the outdoor sunlight, and FIG. 4(B) is a diagram schematically showing the chronological change of the flicker rate under the indoor fluorescent light.

FIG. 5 is a diagram for describing operation of a mobile device according to a second embodiment of the present invention.

FIG. 6 is a block diagram schematically showing a configuration of a mobile device according to a third embodiment of the present invention.

FIG. 7 is a block diagram schematically showing a configuration of a mobile device according to a fourth embodiment of the present invention.

### MODES FOR CARRYING OUT THE INVENTION

Hereinafter, first to fourth embodiments of the present invention will be described with reference to the accompanying drawings. In the following, m and n are each an integer of two or more. Moreover, in the following, light radiated from a backlight unit is referred to as “light from backlight”, and an luminance of the light from backlight passing through a liquid crystal panel is referred to as a “surface luminance”, and a luminance of the light from backlight is referred to as a “backlight luminance”.

### 1. First Embodiment

### 1.1 Overall Configuration

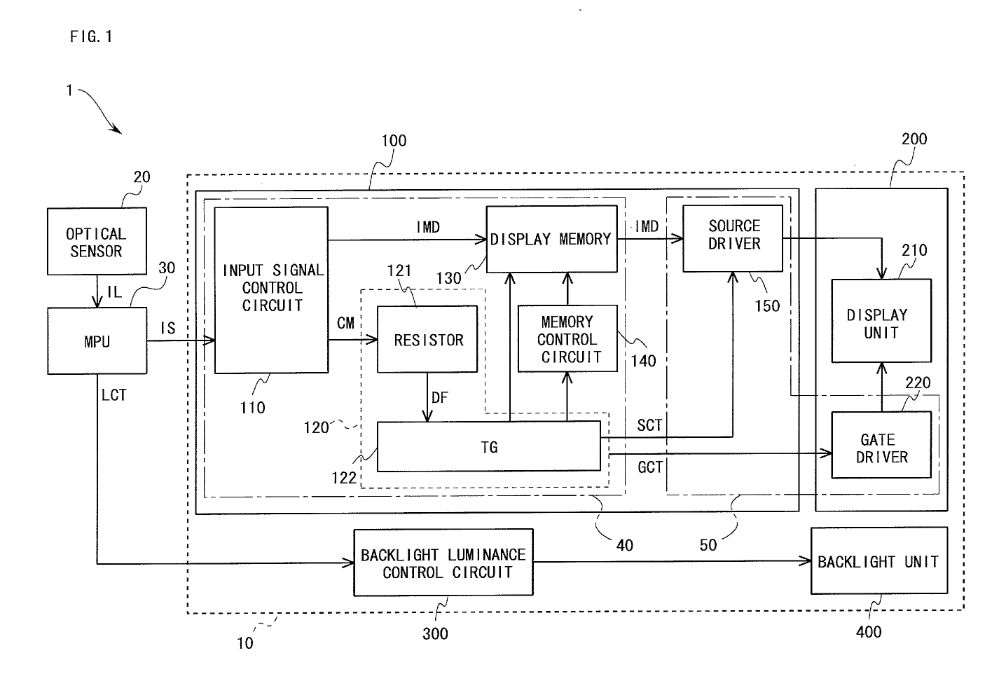

FIG. 1 is a block diagram showing a configuration of a mobile device 1 as an electronic device according to a first embodiment of the present invention. As shown in FIG. 1, the mobile device 1 includes a liquid crystal display device 10, an optical sensor 20, and an MPU (Micro Processing Unit) 30. In the present embodiment, an ambient illuminance acquiring unit is implemented by the optical sensor 20, and an information processing unit is implemented by the MPU 30.

The liquid crystal display device 10 includes an LCD driver 100, a liquid crystal panel 200, a backlight luminance control circuit 300, and a backlight unit 400. In the present embodiment, the light source control unit is implemented by the backlight luminance control circuit 300, and a light source unit is implemented by the backlight unit 400. The backlight luminance control circuit 300 may be implemented as a component outside the liquid crystal display device 10. The liquid crystal display device 10 performs image display based on an input signal IS supplied from the MPU 30.

The optical sensor 20 acquires an ambient illuminance IL in the mobile device 1 to supply this to the MPU 30. The optical sensor 20 has at least a photoelectric converting element unit, and does not necessarily need to have a function of amplification, mathematical operation, or the like, and these may be performed in different circuits. Moreover, the optical sensor 20 does not necessarily need to be used as the ambient illuminance acquiring unit, and a different circuit or the like capable of acquiring the ambient illuminance IL may be used.

The MPU 30 receives the ambient illuminance IL from the optical sensor 20 to generate a command CM based on the relevant ambient illuminance IL. Moreover, the MPU 30 generates image data IMD indicating an image to be displayed. The MPU 30 supplies an input signal IS including the command CM and the image data IMD to the liquid crystal display device 10. The command CM corresponds to an input signal for control, and also corresponds to a signal indicating which of the low-frequency refresh drive and the ordinary drive is to be performed. Moreover, the MPU 30 generates a lighting control signal LCT to supply this to the backlight luminance control circuit 300. The lighting control signal LCT is typically a PWM (Pulse Width Modulation) signal subjected to pulse width modification. However, a duty ratio of the lighting control signal LCT in the present embodiment is set to a fixed value, for example, in both a refresh period RP and a pause period SP.

The LCD driver 100 includes a display control circuit 40 and a source driver (data line drive circuit) 150, and is typically implemented as an IC (Integrated Circuit). The source driver 150 may be provided outside the LCD driver 100.

The liquid crystal panel 200 is of a transmission type or of a semitransmission type, and includes a display unit 210 and a gate driver (scanning line drive circuit) 220. Moreover, the liquid crystal panel 200 employs a normally black system. A drive circuit 50 is configured by the source driver 150 and the gate driver 220. The gate driver 220 in the present embodiment is formed in the liquid crystal panel 200 integrally with the display unit 210, but the present invention is not limited thereto. In the case where the source driver 150 is provided outside the LCD driver 100 as described above, the source driver 150 may be formed in the liquid crystal panel 200 integrally with the display unit 210.

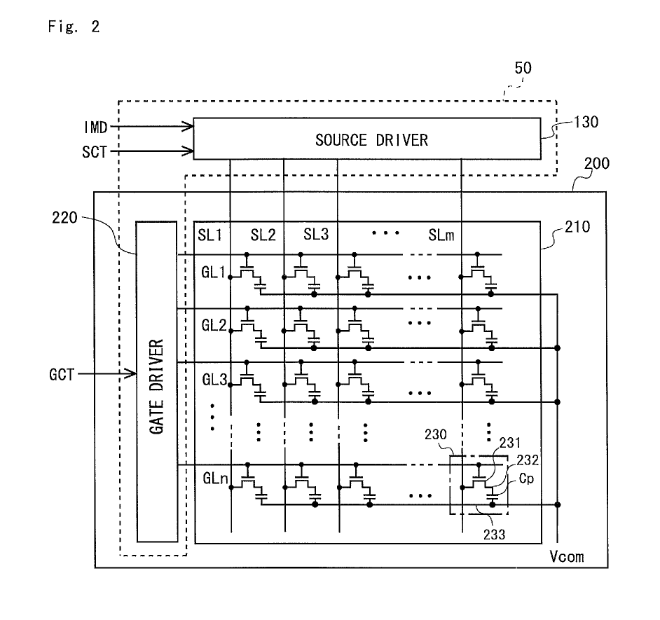

FIG. 2 is a block diagram for describing a configuration of the display unit 210. In the display unit 210, there are formed m source lines (data lines) SL1 to SLm, n gate lines (scanning lines) GL1 to GLn, and m×n pixel formation portions 230 provided corresponding to intersections between these m source lines SL1 to SLm and n gate lines GL1 to GLn. In the following, when the m source lines SL1 to SLm are not distinguished, they are simply referred to as “source lines SL”, and when the n gate lines GL1 to GLn are not distinguished, they are simply referred to as “gate line GLs”. The m×n pixel formation portions 230 are formed in matrix.

Each of the pixel formation portions 230 is configured by a TFT 231 having a gate terminal connected to the gate line GL passing the corresponding intersection, and a source terminal connected to the source line SL passing the relevant intersection, a pixel electrode 232 connected to a drain terminal of the relevant TFT 231, a common electrode 233 provided commonly to the m×n pixel formation portions 230, and a liquid crystal layer sandwiched between the pixel electrode 232 and the common electrode 233, and provided commonly to the m×n pixel formation portions 230. In this manner, the pixel electrode 232 is connected to the corresponding source line SL through the TFT 231. A common potential Vcom is supplied to the common electrode 233 from a common electrode drive circuit (not shown). A pixel capacitance Cp is configured by a liquid crystal capacitance formed by the pixel electrode 232 and the common electrode 233. Since typically, an auxiliary capacitance is provided in parallel to the liquid crystal capacitance to reliably hold a voltage, the pixel capacitance Cp is actually configured by the liquid crystal capacitance and the auxiliary capacitance.

In the present embodiment, as the TFT 231, a TFT using, for example, an oxide semiconductor for a channel layer (hereinafter, referred to as an “oxide TFT”) is used. More specifically, the channel layer of the TFT 231 is formed of IGZO (INGaZnOx) containing indium (In), gallium (Ga), zinc (Zn), and oxygen (O) as main components. Hereinafter, the TFT using IGZO for the channel layer is referred to as an “IGZO-TFT”. In the IGZO-TFT, a leak current is much smaller than that of a silicon-based TFT, a silicon-based TFT using amorphous silicon or the like for the channel layer. This allows a voltage written in the pixel capacitance Cp (a liquid crystal application voltage) to be held for a longer time. As an oxide semiconductor other than IGZO, when, for example, an oxide semiconductor containing at least one of indium, gallium, zinc, copper (Cu), silicon (Si), tin (Sn), aluminum (Al), calcium (Ca), germanium (Ge), lead (Pb) and the like is used for the channel layer, a similar effect can also be obtained. Moreover, the use of the oxide TFT as the TFT 231 is merely one example, and in place of the oxide TFT, the silicon-based TFT or the like may be used.

The display control circuit 40 receives the input signal IS from the MPU 30 to control the source driver 150 and the gate driver 220, based on the relevant input signal IS. The display control circuit 40 specifically generates and outputs the image data IMD, a source control signal SCT, and a gate control signal GCT, based on the input signal IS. The image data IMD and the source control signal SCT are supplied to the source driver 150, and the gate control signal GCT is supplied to the gate driver 220. Moreover, in the pause period SP, the display control circuit 40 stops outputs of, for example, the image data IMD, the source control signal SCT, and the gate control signal GCT, or sets the outputs to fixed potentials. This can reduce power consumption. A detailed configuration of the display control circuit 40 will be described later.

The source driver 150 generates and outputs a data signal to be supplied to the source lines SL, based on the image data IMD and the source control signal SCT in the refresh period RP. The source control signal SCT includes, for example, a source start pulse signal, a source clock signal, a latch strobe signal and the like. The source driver 150 generates a data signal by operating a shift resistor, a sampling latch circuit and the like (not shown) therein, based on the source start pulse signal, the source clock signal, and the latch strobe signal, and converting a digital signal obtained based on the image data IMD to an analog signal in a D/A converter circuit (not shown). On the other hand, in the pause period SP, the outputs of the image data IMD and the source control signal SCT are stopped, or the outputs are set to the fixed potentials, so that the source driver 150 stops the supply of the data signal to the source lines SL.

The gate driver 220 performs supply of an active scanning signal to the gate lines GL, based on the gate control signal GCT in the refresh period RP, so that scanning of the gate lines GL is performed. The gate control signal GCT includes, for example, a gate clock signal and a gate start pulse signal. The gate driver 220 operates a shift resistor (not shown) therein, and generates the scanning signal, based on the gate clock signal and the gate start pulse signal. In the refresh period RP, the respective gate lines GL are sequentially selected to turn on the TFTs 231 in the corresponding pixel formation portions 230, which allows a voltage of the data signal (a data voltage) to be applied to the pixel electrodes 232 through the corresponding source line SL. Thereby, the refresh is performed. On the other hand, in the pause period SP, the gate driver 220 stops the scanning of the gate lines GL by stopping the output of the gate control signal GCT or by setting the output to the fixed potential. Therefore, in the pause period SP, the refresh is not performed.

The backlight unit 400 is provided on a back surface side of the liquid crystal panel 200 to radiate light from backlight to a back surface of the liquid crystal panel 200. The backlight unit 400 typically includes a plurality of LEDs (Light Emitting Diodes) as a plurality of light sources. In place of the LEDs, for example, a CCFL (Cold Cathode Fluorescent Lamp) may be used.

The backlight luminance control circuit 300 includes an LED driver (not shown). The LED driver sets a high level period of the lighting control signal LCT as a lighting period of the LEDs in the backlight unit 400, and a low level period as a non-lighting period of the LEDs. In the present embodiment, since the duty ratio of the lighting control signal LCT is set to the fixed value, a level of the backlight luminance is constant.

The configuration of the display control circuit 40 will be further described. As shown in FIG. 1, the display control circuit 40 includes an input signal control circuit 110 as an input unit, a drive frequency control unit 120, a display memory 130, and a memory control circuit 140.

The input signal control circuit 110 receives the input signal IS from the MPU 30. The input signal IS includes the image data IMD and the command CM, as described above. The input signal control circuit 110 supplies the command CM of the received input signal IS to the drive frequency control unit 120, and supplies the image data IMD to the display memory 130.

The drive frequency control unit 120 selects which of the low-frequency refresh drive and the ordinary drive is to be performed, based on the command CM. Furthermore, when the low-frequency refresh drive is performed, the drive frequency control unit 120 changes a drive frequency DF (also referred to as a refresh rate) determined by a ratio between the refresh period RP and the pause period SP, based on the command CM. The drive frequency control unit 120, more specifically, includes a resistor 121 and a timing generator (hereinafter, abbreviated as a “TG”) 122. In the present embodiment, a storage unit is implemented by the resistor 121, and a drive control unit is implemented by the TG 122.

The resistor 121 prestores a plurality of types of drive frequencies DF to be used during the low-frequency refresh drive in accordance with a plurality of types of ambient illuminances IL, respectively. In the following, the ambient illuminance IL obtained in the optical sensor 20 is referred to as a “measured ambient illuminance”, and the ambient illuminance IL corresponding to each of the types of drive frequencies DF stored by the resistor 121 may be referred to as a “first reference ambient illuminance”. In the present embodiment, for example, a configuration can be employed in which the first reference ambient illuminances and the drive frequencies DF are previously associated with each other in a table. Moreover, the resistor 121 prestores the drive frequency DF to be used during the ordinary drive. The drive frequency DF to be used during the ordinary drive may be of one type or of a plurality of types.

Upon receiving the command CM from the input signal control circuit 110, the resistor 121 selects which of the low-frequency refresh drive and the ordinary drive is to be performed. When the low-frequency refresh drive is performed, the resistor 121 determines the measured ambient illuminance, based on the received command CM to determine the first reference ambient illuminance corresponding to the relevant measured ambient illuminance. The resistor 121 selects the drive frequency DF corresponding to the determined first reference ambient illuminance. The resistor 121 specifically selects the higher drive frequency DF (however, lower than the drive frequency DF during the ordinary drive) as the measured ambient illuminance is higher. On the other hand, when the ordinary drive is performed, the resistor 121 selects the drive frequency DF to be used during the ordinary drive. When the first reference ambient illuminance matching the measured ambient illuminance does not exist, for example, the resistor 121 can select the first reference ambient illuminance closest to the relevant measured ambient illuminance as the first reference ambient illuminance corresponding to the relevant measured ambient illuminance. Moreover, the MPU 30 may convert the measured ambient illuminance to the first reference ambient illuminance to generate the command CM, based on the relevant first reference ambient illuminance.

The TG 122 controls drive timing of the source lines SL by the source driver 150, and drive timing of the gate lines GL by the gate driver 220, based on the drive frequency DF selected by the resistor 121. Specifically, the TG 122 supplies the source control signal SCT and the gate control signal GCT for performing the drive at the drive frequency DF to the source driver 150 and the gate driver 220, respectively. Moreover, the TG 122 controls the display memory 130 and the memory control circuit 140, based on the drive frequency DF. In the following, the drive of the source lines SL and the drive of the gate lines GL may be collectively referred to as “drive of the display unit 210”.

The memory control circuit 140 controls the display memory 130, based on the control by the TG 122. The display memory 130 holds the image data IMD of one frame received from the input signal control circuit 110, based on the control by the TG 122 and the memory control circuit 140. Moreover, the display memory 130 supplies the held image data IMD to the source driver 150 on a line basis, based on the control of the TG 122 and the memory control circuit 140. The display memory 130 may be controlled by any one of the TG 122 and the memory control circuit 140. In the present embodiment, since the image data IMD of one frame is held in the display memory 130, the image data IMD does not necessarily need to be supplied to the display control circuit 40 during the low-frequency refresh drive to display a still picture except for at the time of image update.

As described above, the mobile device 1 according to the present embodiment can drive the liquid crystal display device 10 at the drive frequency DF in accordance with the ambient illuminance IL during the low-frequency refresh drive.

### 1.2 Operation

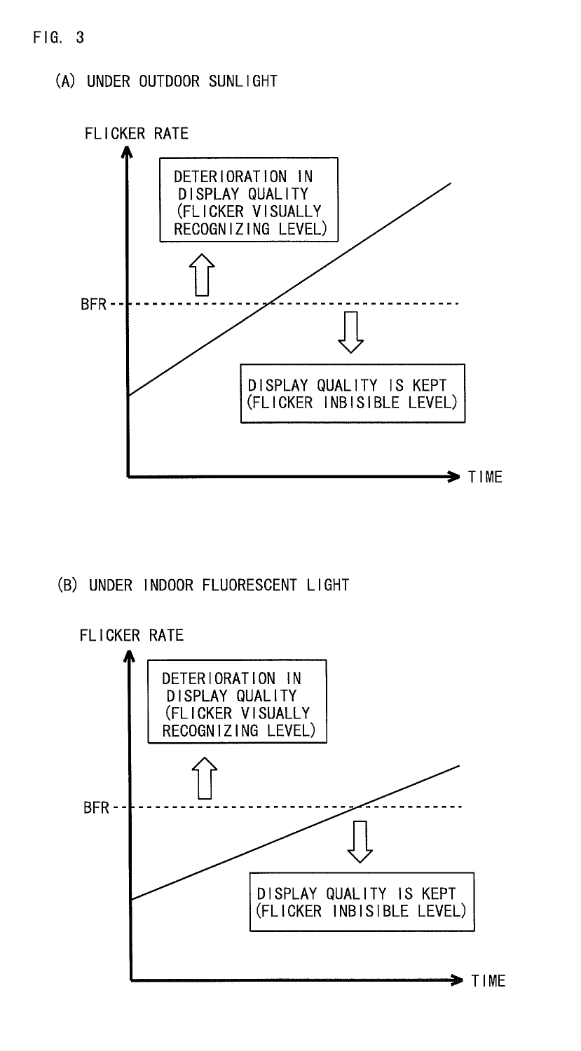

Before describing operation of the mobile device 1 according to the present embodiment, an influence of the leak current on the display quality will be described. FIGS. 3(A) and 3(B) are diagrams schematically showing chronological change of a flicker rate in accordance with the ambient illuminance IL, when the refresh is not performed again after the refresh. More specifically, FIG. 3(A) is a diagram schematically showing chronological change of the flicker rate under outdoor sunlight, and FIG. 3(B) is a diagram schematically showing chronological change of the flicker rate under indoor fluorescent light. Here, the flicker rate is a value obtained by dividing a difference between a maximum value and a minimum value of a surface luminance in a predetermined period by an average value of the surface luminance.

Under the outdoor sunlight, the ambient illuminance IL is higher than that under the indoor fluorescent light. This makes the leak current larger under the outdoor sunlight, as compared with the indoor fluorescent light. In turn, this makes larger fluctuation of the liquid crystal application voltage to be held at the off time under the outdoor sunlight, as compared with under the indoor fluorescent light. Accordingly, as shown in FIGS. 3(A) and 3(B), the chronological change of the flicker rate under the outdoor sunlight is relatively larger, and the chronological change of the flicker rate under the indoor fluorescent light is relatively small.

Here, “BFR” shown in FIGS. 3(A) and 3(B) denotes a flicker rate as a reference when a viewer recognizes the change of the surface luminance as flicker (hereinafter, referred to as a “reference flicker rate”). In the case of the flicker rate beyond the reference flicker rate BFR, since the viewer recognizes flicker, the display quality is deteriorated. On the other hand, in the case of the flicker rate below the reference flicker rate BFR, since the viewer does not recognize the flicker, the display quality is kept. In the following, a value of the flicker rate beyond the reference flicker rate BFR is referred to as a “flicker virtually recognizing level”, and a value of the flicker rate below the reference flicker rate BFR is referred to as a “flicker invisible level”.

As shown in FIG. 3(A), under the outdoor sunlight, since the chronological change of the flicker rate is relatively large, a period from a time point of refresh completion to arrival of the flicker rate at the flicker visually recognizing level is relatively short. On the other hand, as shown in FIG. 3(B), under the indoor fluorescent light, since the chronological change of the flicker rate is relatively small, the period from the time point of refresh completion to the arrival of the flicker rate at the flicker visually recognizing level is relatively long. As described above, it is found that timing when the refresh is again performed to prevent the display quality from being deteriorated (to prevent the flicker from being visually recognized), that is, the drive frequency DF to be employed differs depending on the ambient illuminance IL.

Next, the operation of the mobile device 1 according to the present embodiment will be described. In the present embodiment, as described above, the resistor 121 supplies the drive frequency DF in accordance with the ambient illuminance IL to the TG 122, by which the low-frequency refresh drive is performed, based on the drive frequency DF in accordance with the ambient illuminance IL. Specifically, as the ambient illuminance IL is higher, the drive frequency DF is set higher. However, as described above, the drive frequency DF during the low-frequency refresh drive does not exceed the drive frequency DF during the ordinary drive. This can reduce the power consumption during the low-frequency refresh drive, as compared with during the ordinary drive.

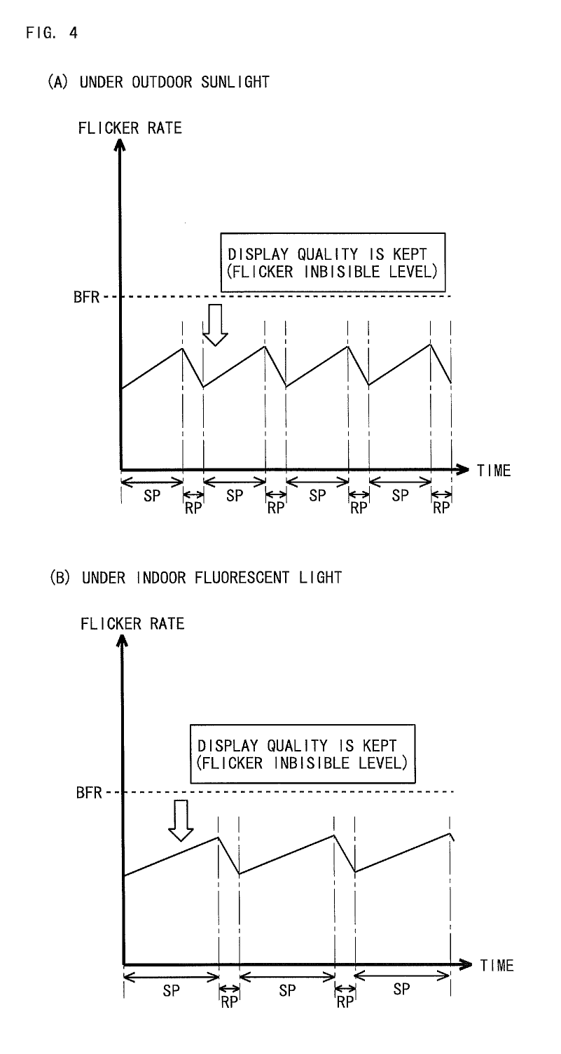

FIGS. 4(A) and 4(B) are diagrams schematically showing the chronological change of the flicker rate in accordance with the ambient illuminance IL in the present embodiment. More specifically, FIG. 4(A) is a diagram schematically showing the chronological change of the flicker rate under the outdoor sunlight, and FIG. 4(B) is a diagram schematically showing the chronological change of the flicker rate under the indoor fluorescent light. As described above, the ambient illuminance IL is higher under the outdoor sunlight than that under the indoor fluorescent light. Thereby, as shown in FIGS. 4(A) and 4(B), the drive frequency DF is set relatively high under the outdoor sunlight (the pause period SP is set relatively short), and relatively low under the indoor fluorescent light (the pause period SP is set relatively long). Thus, under the outdoor sunlight where the chronological change of the flicker rate is relatively large, a period from the time point of the refresh completion to the start of the next refresh is relatively short. On the other hand, under the indoor fluorescent light where the chronological change of the flicker rate is relatively small, the period from the time point of the refresh completion to the start of the next refresh is relatively long. In this manner, the refresh is performed at intervals in accordance with the ambient illuminance IL, as shown in FIGS. 4(A) and 4(B), by which a change amount of the flicker rate is made substantially the same between under the outdoor sunlight and under the indoor fluorescent light, and the flicker rate can be reduced to the flicker invisible level in each of the above-described circumstances.

If the drive frequency DF is fixed to a value under the outdoor sunlight, the power consumption will be unnecessarily increased under the indoor fluorescent light. On the other hand, if the drive frequency DF is fixed to a value under the indoor fluorescent light, the flicker rate will reach the flicker visually recognizing level under the outdoor sunlight. In contrast, in the present embodiment, since the drive frequency DF is set in accordance with the ambient illuminance IL, the flicker rate can be reduced to the flicker invisible level while reducing the power consumption as much as possible.

### 1.3 Effects

According to the present embodiment, the drive frequency DF is determined based on the command CM in accordance with the ambient illuminance IL at the time of the low-frequency refresh drive. Thus, the refresh is performed at intervals in accordance with the ambient illuminance IL. Moreover, since the operation in accordance with the ambient illuminance IL is performed based on the command CM supplied from the MPU 30 outside the liquid crystal display device 10, a dedicated circuit does not need to be provided inside the liquid crystal panel 200. Accordingly, deterioration in display quality depending on the ambient illuminance IL can be reduced at low cost.

Moreover, according to the present embodiment, the drive frequency DF in accordance with the ambient illuminance IL is selected from the plurality of types of drive frequencies DF prestored in the resistor 121, so that the drive based on the relevant drive frequency DF is performed. This makes it unnecessary to calculate the drive frequency DF every time the display control circuit 40 receives the command CM. In turn, this makes it unnecessary to separately provide a circuit to calculate the drive frequency DF or the like, which can further reduce the costs.

Moreover, according to the present embodiment, not only the low-frequency refresh drive but the ordinary drive can be performed based on the command CM.

Furthermore, according to the present embodiment, an IGZO-TFT is used as the TFT 231 inside each of the pixel formation portions 230. This allows the voltage written in the pixel formation portion 230 (the liquid crystal application voltage) to be sufficiently held. Thereby, even if the pause period SP is set longer, the deterioration in display quality is difficult to occur.

### 2. Second Embodiment

### 2.1 Operation

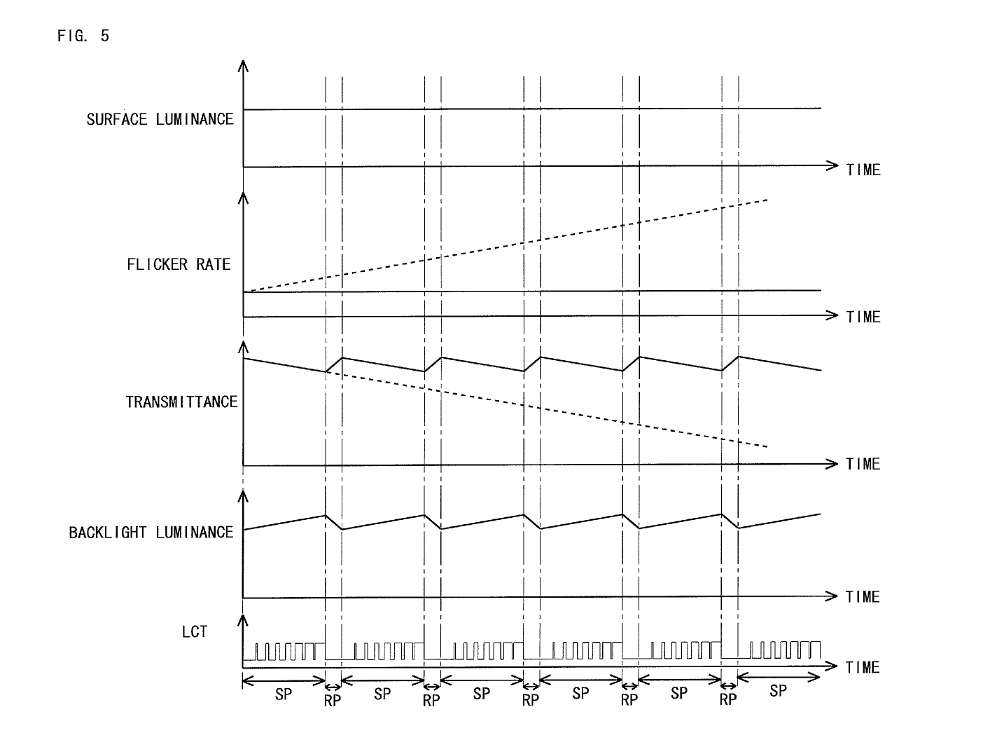

A mobile device 1 according to a second embodiment of the present invention compensates decrease of a transmittance by a lighting control signal LCT having a duty ratio based on an ambient illuminance IL. A configuration of the mobile device 1 according to the present embodiment is similar to that in the first embodiment, and thus, a description thereof will be omitted. FIG. 5 is a diagram for describing operation of the mobile device 1 according to the present embodiment. A surface luminance, a flicker rate, a transmittance, a backlight luminance, and the lighting control signal LCT are shown from the top in the figure. Here, operation during the low-frequency refresh drive will be noted and described.

An MPU 30 generates the lighting control signal LCT. Moreover, the MPU 30 determines the duty ratio of this lighting control signal LCT, based on the ambient illuminance IL. The transmittance shown in FIG. 5 decreases with reduction of electric charges to be held at the off time, which is caused by a leak current. Since a magnitude of the leak current differs depending on the ambient illuminance IL as described above, a decrease amount of the transmittance can be calculated based on the ambient illuminance IL. Thereby, the duty ratio of the lighting control signal LCT for compensating the decrease of the transmittance can be calculated based on the ambient illuminance IL. For example, the MPU 30 prestores a plurality of types of duty ratios (more specifically, they refer to rates of increase in the duty ratio from a start point of each pause period SP to an end point thereof, but hereinafter, may be simply referred to as “duty ratios”), based on a respective plurality of types of ambient illuminances. In the following, the ambient illuminances IL corresponding to the plurality of types of duty ratios may be referred to as “second reference ambient illuminances”. For example, a configuration can be employed in which the second reference ambient illuminances and the duty ratios are previously associated with each other in a table.

Upon receiving the ambient illuminance IL (measured ambient illuminance) from an optical sensor 20, the MPU 30 selects the second reference ambient illuminance corresponding to the relevant ambient illuminance IL. The MPU 30 generates the lighting control signal LCT having the duty ratio based on the selected second reference ambient illuminance to supply this to a backlight luminance control circuit 300. When the second reference ambient illuminance matching the measured ambient illuminance does not exist, for example, operation similar to that when the first reference ambient illuminance matching the measured ambient illuminance does not do in the first embodiment can be performed.

An LED driver included in the backlight luminance control circuit 300, An LED driver, sets a high level period of the lighting control signal LCT as a lighting period of LEDs in a backlight unit 400 and a low level period as a non-lighting period of the LEDs, as described above. Thus, the backlight unit 400 is controlled so as to make the backlight luminance higher as the duty ratio of the lighting control signal LCT is higher. The duty ratio of the lighting control signal LCT becomes higher from the start point of the pause period SP to the end point thereof. This makes the backlight luminance higher from the start point of the pause period SP to the end point thereof. Thereby, as shown in FIG. 5, the decrease of the transmittance from the start point of the pause period SP to the end period thereof is compensated, so that the surface luminance is substantially uniformized. As a result, the flicker rate is further reduced, as compared with the first embodiment. In the refresh period RP, the duty ratio of the lighting control signal LCT becomes lower than that at the end point of the pause period SP. This makes the backlight luminance lower.

As described above, as the ambient illuminance IL is higher, the leak current is larger, and thus, a rate of decrease of the transmittance becomes higher. Thus, the MPU 30 varies the change in the duty ratio of the lighting control signal LCT, based on the ambient illuminance IL. More specifically, the MPU 30 makes higher the rate of increase in the duty ratio of the lighting control signal LCT from the start point of the pause period SP to the end point thereof, as the ambient illuminance IL becomes higher. Thereby, as the ambient illuminance IL is higher, the rate of increase of the backlight luminance becomes higher from the start point of the pause period SP to the end point thereof. As a result, regardless of the ambient illuminance IL, the decrease of the transmittance from the start point of the pause period SP to the end period thereof is compensated, so that the surface luminance is substantially uniformized.

### 2.2 Effects

According to the present embodiment, the lighting control signal LCT having the duty ratio based on the ambient illuminance IL is supplied to the backlight luminance control circuit 300 from the MPU 30, so that the backlight luminance becomes at a level in accordance with the ambient illuminance IL. Thus, the backlight luminance changes along with the change of the transmittance when the refresh is performed at intervals in accordance with the ambient illuminance IL. This can further suppress the deterioration in display quality. During the ordinary drive, since the operation in accordance with the ambient illuminance IL is not performed, the constant backlight luminance suffices, but it is desirable that the backlight luminance is at a level in accordance with the drive frequency DF during the ordinary drive.

### 3. Third Embodiment

### 3.1 Overall Configuration and Operation Outline

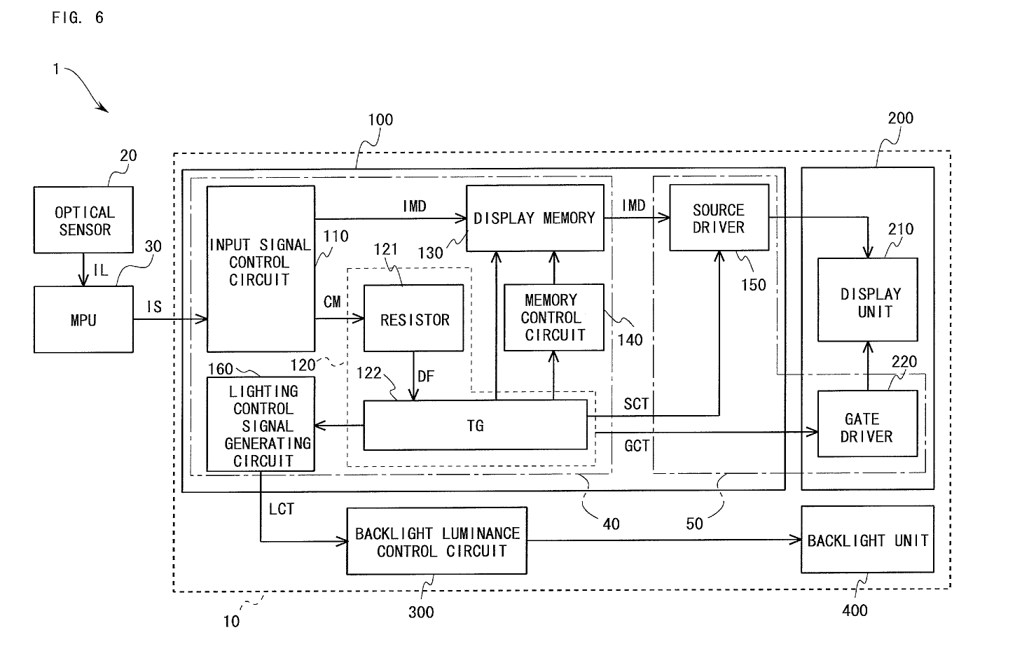

FIG. 6 is a block diagram showing a configuration of a mobile device 1 according to a third embodiment of the present invention. Among components of the present embodiment, the components same as those in the first embodiment will be given the same reference numerals and descriptions thereof will be omitted as needed. In the present embodiment, a lighting control signal generating circuit 160 is further provided in the display control circuit 40 in the first embodiment. Other components are basically similar to those in the first embodiment. Moreover, also in the present embodiment, operation during the low-frequency refresh drive will be noted and described as in the second embodiment.

The lighting control signal generating circuit 160 generates a lighting control signal LCT. Moreover, the lighting control signal generating circuit 160 determines a duty ratio of the lighting control signal LCT, based on a drive frequency DF. The duty ratio of the lighting control signal LCT is, more specifically, controlled by a TG 122 to be thereby set to a value based on the drive frequency DF. The lighting control signal generating circuit 160 supplies the generated lighting control signal LCT to a backlight luminance control circuit 300. The lighting control signal LCT in the present embodiment is a PWM signal similar to that in the second embodiment, and the duty ratio becomes higher from a start point of a pause period SP to an end point thereof. An MPU 30 does not generate the lighting control signal LCT. Since a magnitude of a leak current differs depending on an ambient illuminance IL as described above, a decrease amount of a transmittance can be calculated based on the ambient illuminance IL. Moreover, the drive frequency DF during the low-frequency refresh drive has a value in accordance with the ambient illuminance IL. That is, it is also said that the decrease amount of the transmittance can be calculated based on the drive frequency DF. Thus, the duty ratio of the lighting control signal LCT for compensating the decrease of the transmittance can be calculated based on the drive frequency DF. For example, the lighting control signal generating circuit 160 prestores a plurality of types of duty ratios based on a plurality of types of drive frequencies DF, respectively. For example, a configuration can be employed in which the drive frequencies DF and the duty ratios are previously associated with each other in a table.

Based on the control by the TG 122 (based on an output signal from the TG 122 indicating the drive frequency DF), the lighting control signal generating circuit 160 generates the lighting control signal LCT having the duty ratio based on the drive frequency DF to supply this to the backlight luminance control circuit 300. At least the output signal from the TG 122 needs to be supplied to the lighting control signal generating circuit 160. The output signal from the TG 122 is made of, for example, a reset signal and an enable signal, and these signals implement the duty ratio based on the drive frequency DF. Moreover, in the lighting control signal generating circuit 160, the duty ratio based on the drive frequency DF may be implementable, based on a command transmitted from the MPU 30 or the like based on an SPI (Serial Peripheral Interface) standard. The use of the above-described command is preferable for a case where various outputs are requested to an LED driver. Operations of the backlight luminance control circuit 300 and a backlight unit 400, and basic change of the duty ratio of the lighting control signal LCT from the start point of the pause period SP to the endpoint thereof are similar to those in the second embodiment, and thus, descriptions thereof will be omitted.

As described above, as the ambient illuminance IL is higher, the leak current is larger, and thus, a rate of decrease of the transmittance becomes higher. Moreover, as the ambient illuminance IL is higher, the drive frequency DF is higher. Thus, the lighting control signal generating circuit 160 varies change of the duty ratio of the lighting control signal LCT, based on the drive frequency DF. More specifically, as the drive frequency DF is higher, a rate of increase in the duty ratio of the lighting control signal LCT from the start point of the pause period SP to the endpoint thereof is made higher. Thereby, as the ambient illuminance IL is higher, a rate of increase in backlight luminance from the start point of the pause period SP to the endpoint thereof is higher. As a result, regardless of the ambient illuminance IL, the decrease of the transmittance from the start point of the pause period SP to the end point thereof is compensated, so that a surface luminance is substantially uniformized. Operation during ordinary drive is similar to those in the first and second embodiments.

### 3.2 Effects

According to the present embodiment, the lighting control signal generating circuit 160 is provided inside the display control circuit 40, and the lighting control signal LCT having the duty ratio based on the drive frequency DF is generated in the relevant lighting control signal generating circuit 160, so that similar effects to those in the second embodiment can be obtained. Moreover, since the duty ratio of the lighting control signal LCT is controlled by the TG 122 controlling drive timing of a display unit 210, the backlight luminance can be more reliably synchronized by the drive timing of the display unit 210.

### 4. Fourth Embodiment

### 4.1 Overall Configuration and Operation Outline

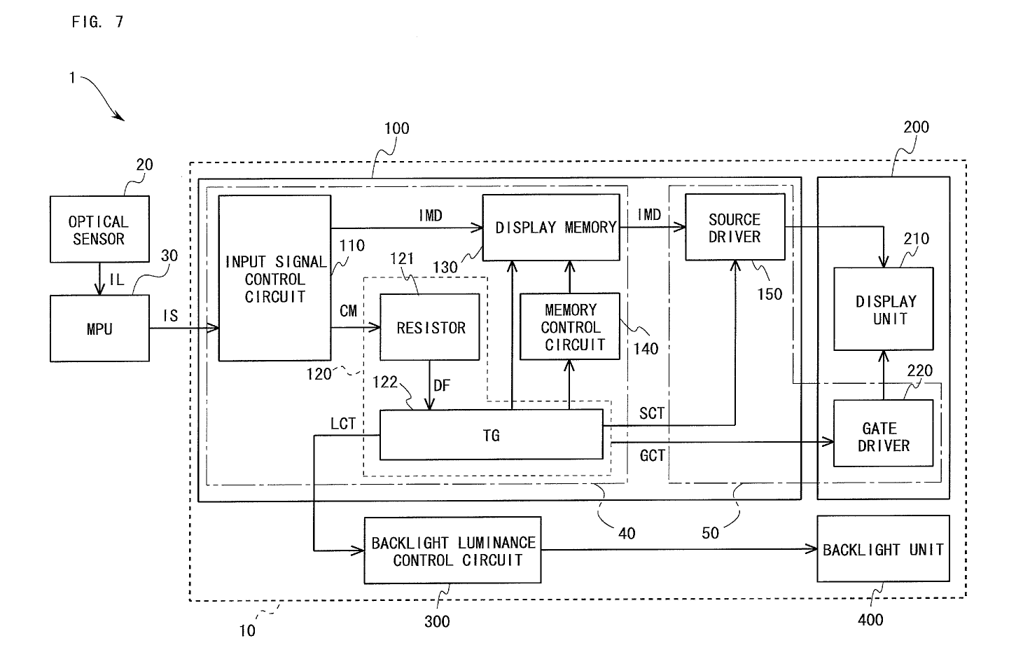

FIG. 7 is a block diagram showing a configuration of a mobile device 1 according to a fourth embodiment of the present invention. Among components of the present embodiment, the components same as those in the first embodiment will be given the same reference numerals and descriptions thereof will be omitted as needed. While the components of the present embodiment are similar to those in the first embodiment, only a generation entity of a lighting control signal LCT is different. Moreover, also in the present embodiment, operation during the low-frequency refresh drive will be noted and described as in the second and third embodiments.

A TG 122 in the present embodiment performs control of a source driver 150, agate driver 220 and the like, and generates a lighting control signal LCT. Moreover, the TG 122 determines a duty ratio of this lighting control signal LCT, based on a drive frequency DF. The lighting control signal LCT in the present embodiment is a PWM signal similar to those in the second and third embodiments, and the duty ratio becomes higher from a start point of a pause period SP to an end point thereof. An MPU 30 does not generate the lighting control signal LCT. The TG 122 prestores a plurality types of duty ratios based on a plurality of types of drive frequencies DF, respectively, similarly to the lighting control signal generating circuit 160 in the third embodiment. For example, a configuration can be employed in which the drive frequencies DF and the duty ratios are previously associated with each other in a table. Operation of the TG 122 in the present embodiment for generating the lighting control signal LCT having the duty ratio based on the drive frequency DF is similar to that of the lighting control signal generating circuit 160 in the third embodiment, and thus, a description thereof will be omitted.

### 4.2 Effects

According to the present embodiment, the lighting control signal LCT having the duty ratio based on the drive frequency DF is generated by the TG 122, so that similar effects to those of the third embodiment can be obtained.

### 5. Others

In the respective embodiments, a description has been given on the premise that the liquid crystal panel 200 is of a transmission type or of a semitransmission type, but the present invention is not limited thereto. Effects similar to the respective embodiments can be obtained by a configuration in which the liquid crystal panel 200 is of a reflection type, and the backlight luminance control circuit 300 and the backlight unit 400 are not provided. Moreover, descriptions have been given on the premise that the liquid crystal panel 200 employs a normally black system, but it may employ a normally white system. Change of the transmittance in the normally white system results from inverting the change in the normally black system. Thus, in the second to fourth embodiments, similar effects can also be obtained in the normally white system by inverting the change of the duty ratio of the lighting control signal LCT, that is, by inverting the change of the backlight luminance.

In the respective embodiments, CABC (Content Adaptive Brightness Control) processing may be further performed, in which the backlight luminance is changed in accordance with contents of the image data IMD held in the display memory 130. In the first embodiment, the duty ratio of the lighting control signal LCT is controlled, based on a brightness of an image indicated by the image data IMD held in the display memory 130. In the second embodiment, the duty ratio of the lighting control signal LCT is controlled, based on the brightness of the image indicated by the image data IMD held in the display memory 130 and the ambient illuminance IL. In the third and fourth embodiments, the duty ratio of the lighting control signal LCT is controlled, based on the brightness of the image indicated by the image data IMD held in the display memory 130 and the drive frequency DF. In this manner, for example, in the case where a dark image is displayed, the backlight luminance can be set low, which can reduce power consumption of the backlight. The third and fourth embodiments in which the lighting control signal LCT is generated inside the LCD driver 100 including the display memory 130 are preferable for the aspect in which the CABC processing is performed.

The aspect in the foregoing description in which the various tables are used is only exemplification, and the drive frequency DF or the duty ratio may be found by calculation. In addition, various modifications can be made to the foregoing embodiments within a range not departing from the gist of the present invention.

As described above, according to the present invention, there can be provided a liquid crystal display device capable of suppressing deterioration in display quality depending on an ambient illuminance IL at low cost, an electronic device including the same, and a method for driving the liquid crystal display device.

### INDUSTRIAL APPLICABILITY

The present invention can be applied to a display device performing low-frequency drive, and a method for driving the same.

### DESCRIPTION OF REFERENCE CHARACTERS

1: MOBILE DEVICE (ELECTRONIC DEVICE)
10: LIQUID CRYSTAL DISPLAY DEVICE
20: OPTICAL SENSOR (AMBIENT ILLUMINANCE ACQUIRING UNIT)
30: MPU (INFORMATION PROCESSING UNIT)
40: DISPLAY CONTROL CIRCUIT
50: DRIVE CIRCUIT
100: LCD DRIVER
110: INPUT SIGNAL CONTROL CIRCUIT (INPUT UNIT)
120: DRIVE FREQUENCY CONTROL UNIT
121: RESISTER (STORAGE UNIT)
122: TG (DRIVE CONTROL UNIT)
130: DISPLAY MEMORY
140: MEMORY CONTROL CIRCUIT
150: SOURCE DRIVER
160: LIGHTING CONTROL SIGNAL GENERATING CIRCUIT
200: LIQUID CRYSTAL PANEL
210: DISPLAY UNIT
220: GATE DRIVER
300: BACKLIGHT LUMINANCE CONTROL CIRCUIT (LIGHT SOURCE CONTROL UNIT)
400: BACKLIGHT UNIT (LIGHT SOURCE UNIT)
CM: COMMAND (INPUT SIGNAL FOR CONTROL)
IL: AMBIENT ILLUMINANCE
DF: DRIVE FREQUENCY
LCT: LIGHTING CONTROL SIGNAL
RP: REFRESH PERIOD
SP: PAUSE PERIOD

1. A liquid crystal display device comprising:
a liquid crystal panel including a plurality of scanning lines, a plurality of data lines, and a plurality of pixel formation portions provided corresponding to the plurality of scanning lines and the plurality of data lines; and
a display control unit that controls drive of the plurality of scanning lines and the plurality of data lines,
wherein each of the pixel formation portions includes a thin film transistor having a gate terminal connected to the corresponding scanning line, and a pixel electrode connected to the corresponding data line through the thin film transistor, and
the display control unit includes:
an input unit that receives an input signal for control based on an ambient illuminance from outside; and
a drive frequency control unit that sets a drive frequency determined by a ratio between a refresh period and a pause period to a value in accordance with the ambient illuminance, based on the input signal for control, when the plurality of scanning lines and the plurality of data lines are to be driven so that the refresh period and the pause period alternately appear, the refresh period being for refreshing a screen of the liquid crystal panel, and the pause period being for pausing the refresh of the screen, the pause period being equal to or longer than the refresh period.

2. The liquid crystal display device according to claim 1, wherein
the drive frequency control unit includes:
a storage unit that prestores a plurality of types of drive frequencies, and selects the drive frequency in accordance with the ambient illuminance from the plurality of types of drive frequencies, based on the input signal for control; and
a drive control unit that controls drive timing of the plurality of scanning lines and the plurality of data lines, based on the drive frequency selected by the storage unit, when the plurality of scanning lines and the plurality of data lines are to be driven so that the refresh period and the pause period alternately appear.

3. The liquid crystal display device according to claim 2, further comprising:
a light source unit that radiates light to the liquid crystal panel; and
a light source control unit that controls the light source unit.

4. The liquid crystal display device according to claim 3, wherein the light source control unit controls a luminance of light to be radiated from the light source unit, based on a lighting control signal subjected to pulse width modulation.

5. The liquid crystal display device according to claim 4, wherein the light source control unit makes the luminance of the light to be radiated from the light source unit higher as a duty ratio of the lighting control signal is higher.

6. The liquid crystal display device according to claim 5, wherein
the display control unit further includes a lighting control signal generating unit that generates the lighting control signal, and
the lighting control signal generating unit determines the duty ratio of the lighting control signal, based on the drive frequency.

7. The liquid crystal display device according to claim 6, wherein the drive control unit controls the duty ratio of the lighting control signal to be determined by the lighting control signal generating unit.

8. The liquid crystal display device according to claim 5, wherein the drive control unit generates the lighting control signal having the duty ratio based on the drive frequency.

9. The liquid crystal display device according to claim 1, wherein the drive frequency control unit sets the drive frequency to a predetermined value, when the plurality of scanning lines and the plurality of data lines are to be driven so that the refresh period continuously appears.

10. The liquid crystal display device according to claim 1, wherein a channel layer of the thin film transistor is formed of an oxide semiconductor.

11. The liquid crystal display device according to claim 5, wherein the light source control unit receives the lighting control signal having the duty ratio based on the ambient illuminance from outside the liquid crystal display device.

12. An electronic device comprising:
the liquid crystal display device according to claim 1;
an ambient illuminance acquiring unit that acquires the ambient illuminance; and
an information processing unit that supplies to the input unit an input signal for control based on the ambient illuminance acquired by the ambient illuminance acquiring unit.

13. An electronic device comprising:
the liquid crystal display device according to claim 11;
an ambient illuminance acquiring unit that acquires the ambient illuminance; and
an information processing unit that supplies to the input unit an input signal for control based on the ambient illuminance acquired by the ambient illuminance acquiring unit, and supplies to the light source control unit a lighting control signal having a duty ratio based on the relevant ambient illuminance.

14. A method for driving a liquid crystal display device which includes a liquid crystal panel and a display control unit, the liquid crystal panel including a plurality of scanning lines, a plurality of data lines, and a plurality of pixel formation portions provided corresponding to the plurality of scanning lines and the plurality of data lines, each of the pixel formation portions including a thin film transistor having a gate terminal connected to the corresponding scanning line, and a pixel electrode connected to the corresponding data line through the thin film transistor, and the display control unit configured to control drive of the plurality of scanning lines and the plurality of data lines, the method comprising the steps of:
receiving an input signal for control based on an ambient illuminance from outside; and
setting a drive frequency determined by a ratio between a refresh period and a pause period to a value in accordance with the ambient illuminance, based on the input signal for control, when the plurality of scanning lines and the plurality of data lines are to be driven so that the refresh period and the pause period alternately appear, the refresh period being for refreshing a screen of the liquid crystal panel, and the pause period being for pausing the refresh of the screen, the pause period being equal to or longer than the refresh period.
